(19) United States
(12) Patent Application Publication
(10) Pub. No.: US 2026/0040314 A1
(43) Pub. Date: Feb. 5, 2026

(54) VECTOR QUANTIZATION METHODS FOR UE-DRIVEN MULTI-VENDOR SEQUENTIAL TRAINING

(71) Applicant: QUALCOMM Incorporated, San Diego, CA (US)

(72) Inventors: Abdelrahman Mohamed Ahmed Mohamed IBRAHIM, San Diego, CA (US); June NAMGOONG, San Diego, CA (US); Taesang YOO, San Diego, CA (US); Jay Kumar SUNDARARAJAN, San Diego, CA (US); Tingfang JI, San Diego, CA (US); Chenxi HAO, Beijing (CN); Naga BHUSHAN, San Diego, CA (US)

(21) Appl. No.: 19/100,526

(22) PCT Filed: Sep. 30, 2022
(86) PCT No.: PCT/CN2022/123021

§ 371 Date: Jan. 31, 2025

(51) Int. Cl. H04W 72/21; H04B 7/06; H04L 41/16

(52) U.S. Cl. CPC H04W 72/21; H04B 7/0626; H04L 41/16

(57) ABSTRACT

A UE-associated entity may train an encoder to encode uplink control information. The UE-associated entity may determine a quantization codebook to be applied to the encoded uplink control information. The UE-associated entity may share a sequential training dataset with a base station-associated entity, the sequential training dataset including: one of an input vector set or an output vector set; and one of an encoded and unquantized intermediate vector set or an encoded and quantized intermediate vector set. The base station-associated entity may train a decoder based on a quantization codebook and at least the sequential training dataset from the UE-associated entity. When the base station-associated entity receives multiple sequential training datasets for different vendors, the base station-associated entity may train a multi-vendor decoder based on the multiple sequential training datasets.

### BACKGROUND

### Technical Field

The present disclosure relates generally to communication systems, and more particularly, to vector quantization methods for UE-driven multi-vendor sequential training.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a method of wireless communication for a user equipment (UE)-associated entity, including: training an encoder to encode uplink control information; determining a quantization codebook to be applied to the encoded uplink control information; and sharing a sequential training dataset with a base station-associated entity, the sequential training dataset including: one of an input vector set or an output vector set; and one of an encoded and unquantized intermediate vector set or an encoded and quantized intermediate vector set.

The present disclosure also provides an apparatus (e.g., a UE-associated entity such as a UE or server) including a memory storing computer-executable instructions and at least one processor configured to execute the computer-executable instructions to perform the above method, an apparatus including means for performing the above method, and a non-transitory computer-readable medium storing computer-executable instructions for performing the above method.

One innovative aspect of the subject matter described in this disclosure can be implemented in a method of wireless communication at a base station (BS)-associated entity including: receiving a sequential training dataset from at least a first user equipment (UE)-associated entity, the sequential training dataset including: one of an input vector set or an output vector set; and one of an encoded and unquantized intermediate vector set or an encoded and quantized intermediate vector set; determining a quantization codebook to be applied to encoded and quantized uplink control information; and training a decoder to decode the encoded and quantized uplink control information based on the sequential training dataset and the quantization codebook.

The present disclosure also provides an apparatus (e.g., a BS-associated entity such as a BS or server) including a memory storing computer-executable instructions and at least one processor configured to execute the computer-executable instructions to perform the above method, an apparatus including means for performing the above method, and a non-transitory computer-readable medium storing computer-executable instructions for performing the above method.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system including an access network, in accordance with certain aspects of the present description.

FIG. 2A is a diagram illustrating an example of a first frame, in accordance with certain aspects of the present description.

FIG. 2B is a diagram illustrating an example of downlink (DL) channels within a subframe, in accordance with certain aspects of the present description.

FIG. 2C is a diagram illustrating an example of a second frame, in accordance with certain aspects of the present description.

FIG. 2D is a diagram illustrating an example of uplink (UL) channels within a subframe, in accordance with certain aspects of the present description.

FIG. 3 is a diagram illustrating an example of a base station and user equipment (UE) in an access network, in accordance with certain aspects of the present description.

FIG. 4 is a diagram illustrating an example disaggregated base station architecture.

FIG. 5 is a message diagram of an example multi-vendor training procedure.

FIG. 6 is a diagram of an example quantization and dequantization procedure.

FIG. 7 is a diagram of an example multi-vendor sequential training system for encoders and decoders with quantization training at a UE associated entities.

FIG. 8 is a diagram of an example multi-vendor sequential training system for encoders and decoders with quantization training at a base station-associated entity.

FIG. 9 is a diagram of an example sequential training system for encoders and decoders with quantization.

FIG. 10 is a flowchart of an example method for channel state feedback reporting using a learned dictionary.

FIG. 11 is a flowchart of an example method for channel state feedback reporting using a learned dictionary.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

In a wireless communication system, channel state feedback (CSF) may be used to determine transmission properties. For example, a user equipment (UE) may transmit channel state information (CSI) to a base station. The CSI may be used by the base station to select downlink transmission properties. The CSI may also be used to schedule the UE for uplink transmissions.

Multiple-input multiple-output (MIMO) antenna technology may increase the dimensionality of CSI. For example, the channel between each pair of antennas may vary. Accordingly, as the number of antennas used in MIMO increases, the overhead to report uplink control information such as CSF and/or CSI may also increase. Various techniques have been proposed to reduce CSI overhead such as codebook-based reporting. Predefined codebooks, however, may reduce the granularity of CSI information. Another proposal for CSI feedback is the use of machine-learning algorithms to compress CSI at the UE and decompress the CSI at the base station. Such proposals are expected to provide gain in feedback accuracy versus payload size.

The training of a machine-learning based system for CSF may pose several problems for real-world communications networks. For example, devices within a wireless network may be manufactured by different vendors such that the devices operate differently, even if complying with regulations and/or standards. For instance, in the case of CSF, devices may have different antenna combinations or proprietary machine-learning models. In one use case, a base station may communicate with UEs from multiple vendors, each having an encoder based on a different machine-learning model. Training and deploying models for each different UE vendor and base station vendor pair may be redundant, consume additional resources, and/or increase complexity. Accordingly, it may be desirable to train a machine-learning model (e.g., a decoder) that operates with encoders of multiple vendors. As another example, machine-learning models may be considered proprietary, and vendors may be unwilling to share model details with other vendors. Accordingly, model training techniques such as joint training with model transfer may be unavailable in a multi-vendor environment.

In an aspect, the present disclosure provides techniques for using sequential training for encoders and decoders with vector quantization. The disclosed techniques may be considered UE-driven because a UE-associated entity (e.g., a UE vendor server or UE itself) may first train at least an encoder, then provide a training set that allows a base station-associated entity (e.g., a base station vendor server or base station) to train a decoder. In various implementations, training for vector quantization and/or dequantization may be performed at the UE associated-entity or the base station-associated entity. The content of the training set may be selected based on a level of agreement between the UE-associated entity and the base station-associated entity regarding quantization training.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. Non-transitory computer-readable media specifically excludes transitory signals. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

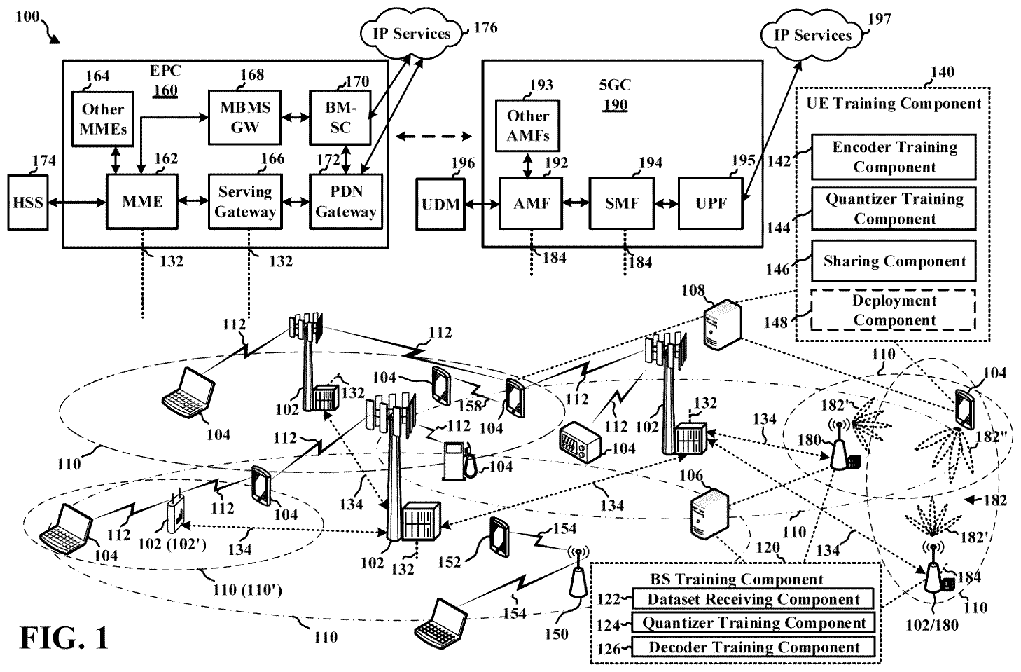

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network (e.g., a 5G Core (5GC) 190). The base stations 102 may include macrocells (high power cellular base station) and/or small cells (low power cellular base station). The macrocells include base stations. The small cells include femtocells, picocells, and microcells. In an aspect, one or more base stations 102 may communicate with a base station vendor server 106. For example, the base station vendor server 106 may be configured to provide firmware or software updates to base stations 102. Similarly, one or more UEs 104 may communicate with a UE vendor server 108, which may be configured to provide firmware or software updates to UEs 104. In some implementations, each UE 104 may communicate with a respective UE vendor server 108 corresponding to a vendor of the UE 104.

One or more of the UEs 104 or UE vendor servers 108 may include a UE training component 140 that performs machine-learning training of models and/or codebooks for a UE 104. The UE 104 or UE vendor server 108 may be referred to as a UE-associated entity. The UE training component 140 may include an encoder training component 142 configured to train, at the UE-associated entity, an encoder to encode uplink control information. The UE training component 140 may include a quantizer training component 144 configured to determine a quantization codebook to be applied to the encoded uplink control information. The UE training component 140 may include a sharing component 146 configured to share a sequential training dataset with a base station-associated entity. The sequential training dataset may include: one of an input vector set (Vᵢₙ) or an output vector set (Vₒᵤₜ) and one of an encoded and unquantized intermediate vector set (zₑ) or an encoded and quantized intermediate vector set (z_{q}).

In an aspect, one or more of the base stations 102 may include a BS training component 120 that performs sequential machine-learning training of models and/or codebooks for a base station 102. For example, the BS training component 120 may include a dataset receiving component 122 configured to receive a sequential training dataset from at least a first UE-associated entity. The sequential training dataset may include: one of an input vector set (Vᵢₙ) or an output vector set (Vₒᵤₜ) and one of an encoded and unquantized intermediate vector set (zₑ) or an encoded and quantized intermediate vector set (z_{q}). The BS training component 120 may include a quantizer training component 124 configured to determine a quantization codebook to be applied to encoded and quantized uplink control information. The BS training component 120 may include a decoder training component 126 configured to train, at the base station-associated entity, a decoder to decode the encoded and quantized uplink control information based on the sequential training dataset and the quantization codebook.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The backhaul links 132 may be wired or wireless. The base stations 102 configured for 5G NR (collectively referred to as Next Generation RAN (NG-RAN)) may interface with 5GC 190 through backhaul links 184. The backhaul links 184 may be wired or wireless. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 112 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 112 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and a physical sidelink feedback channel (PSFCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25GHz-52.6 GHz). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 one or more transmit beams 182′. The UE 104 may receive the beamformed signal from the base station 180 on one or more receive beams 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. In the case of a synchronous network, cells from base stations 180 may be generally aligned. A different receive beam 182″ may provide the best performance for each cell. A UE may perform a neighbor cell search and beam measurements to identify the best receive beam 182″ for each cell.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

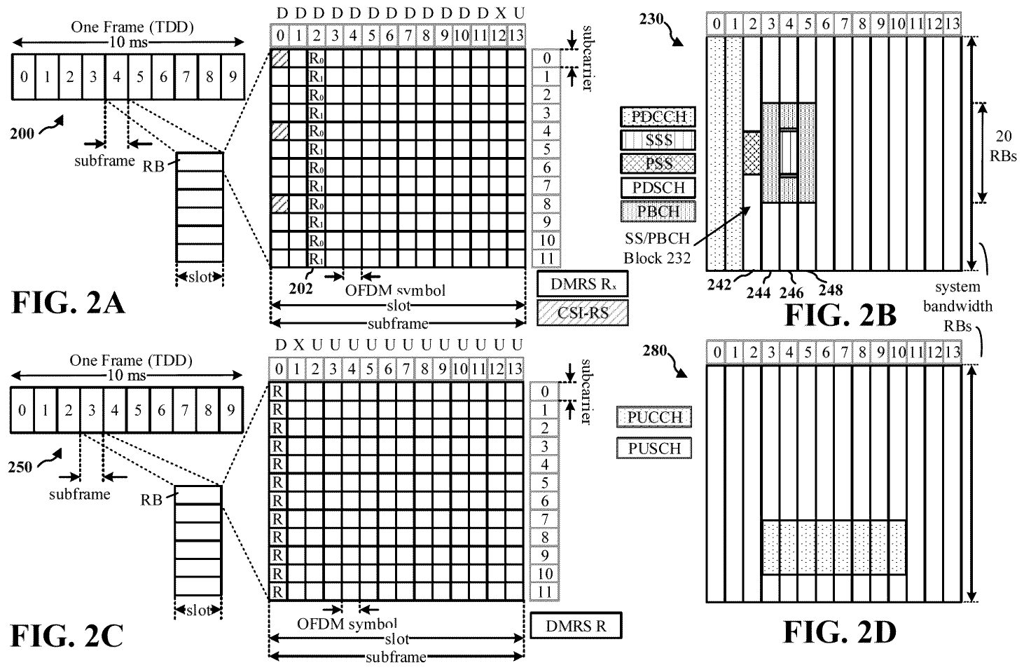

FIGS. 2A-2D are resource diagrams illustrating example frame structures and channels that may be used for uplink, downlink, and sidelink transmissions to a UE 104 including a UE training component 140. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology u=5 has a subcarrier spacing of 480kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) 202 (indicated as Rx for one particular configuration, where 100× is the port number, but other DMRS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 (e.g., a PSS symbol 242) of particular subframes of a frame. The PSS is used by a UE 104 to determine subframe/symbol timing and a physical layer identity. A secondary synchronization signal (SSS) may be within symbol 4 (e.g., a SSS symbol 246) of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DMRS 202. The physical broadcast channel (PBCH), which carries a master information block (MIB), may be logically grouped with the PSS and SSS to form a synchronization signal (SS)/PBCH block, also referred to as an SSB 232. The PBCH may be transmitted over symbols 3-5 of a subframe, with symbols 3 and 5, for example, being referred to as PBCH symbols 244, 248 because those symbols include mostly RBs for the PBCH. The DMRS 202 may be interleaved with the RBs for the PBCH (e.g., every fourth RB) to allow decoding of the PBCH. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DMRS (indicated as R for one particular configuration, but other DMRS configurations are possible) for channel estimation at the base station. The UE may transmit DMRS for the physical uplink control channel (PUCCH) and DMRS for the physical uplink shared channel (PUSCH). The PUSCH DMRS may be transmitted in the first one or two symbols of the PUSCH. The PUCCH DMRS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

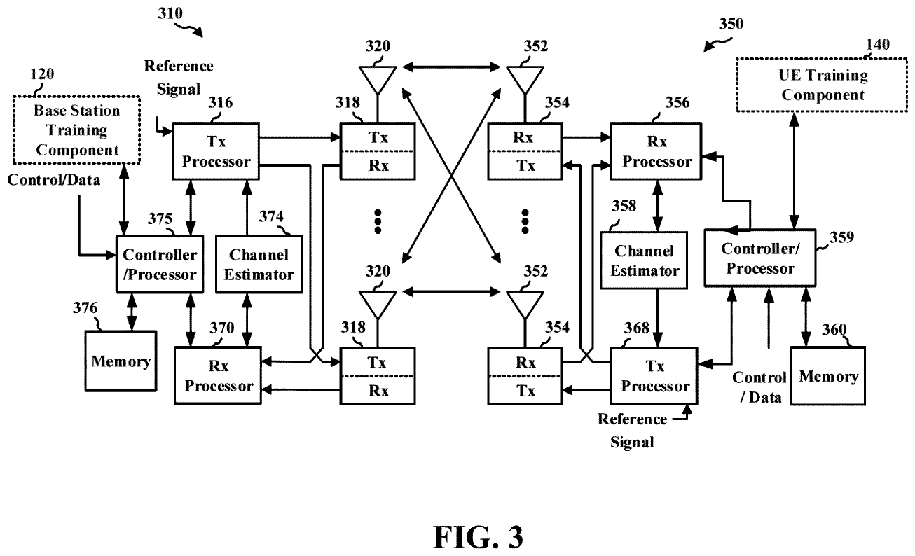

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate an RF carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160 or 5GC 190. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the UE training component 140 of FIG. 1. For example, the memory 360 may include executable instructions defining the UE training component 140. The Tx processor 368, the Rx processor 356, and/or the controller/processor 359 may be configured to execute the UE training component 140.

At least one of the Tx processor 316, the Rx processor 370, and the controller/processor 375 may be configured to perform aspects in connection with the BS training component 120 of FIG. 1. For example, the memory 376 may include executable instructions defining the BS training component 120. The Tx processor 316, the Rx processor 370, and/or the controller/processor 375 may be configured to execute the BS training component 120.

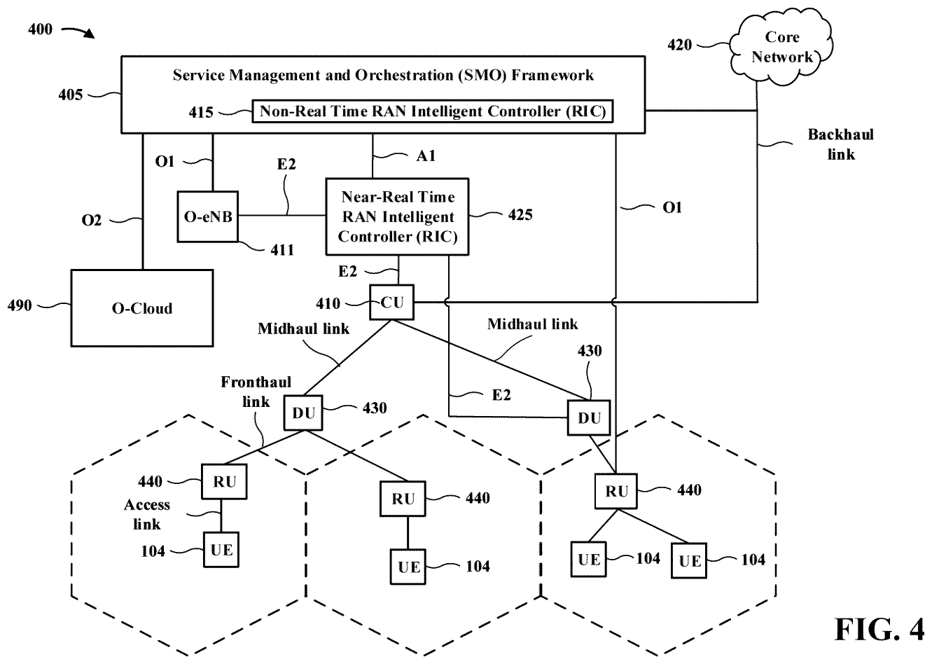

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

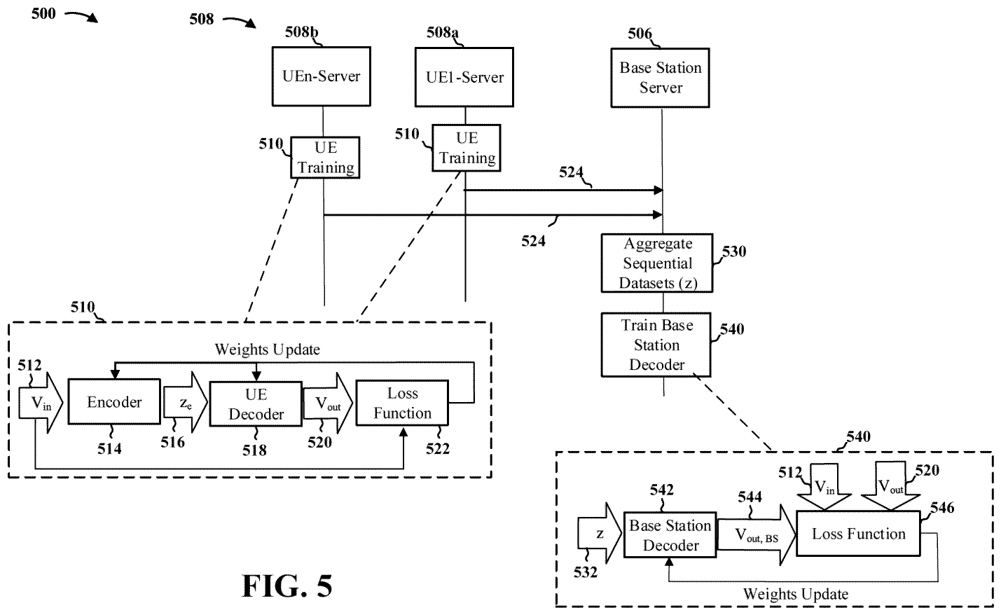

FIG. 5 is a message diagram of an example multi-vendor training procedure 500. The procedure 500 may be performed between multiple UE-associated entities 508 (e.g., UE-vendor servers 508a and 508b) and a base station-associated entity 506 (e.g., a base station server). The UE-associated entities 508 may include the UE training component 140, and the base station-associated entity 506 may include the BS training component 120. The procedure 500 may be UE-driven in that the UE-associated entities 508 perform the initial training in the sequential training. For example, the UE-associated entities 508 may each perform UE training 510 to train an encoder 514. In an aspect, the encoder 514 is machine-learning model such as a neural network.

The UE training 510 may start with an input vector set (Vᵢₙ) 512. For example, the Vᵢₙ 512 may be vectors representing uplink control information such as CSF or CSI for a UE 104 to report to a base station 102. The Vᵢₙ 512 may be collected from one or more UEs 104, generated in a modeling or testing environment, curated, and/or synthesized. In some implementations, Vᵢₙ 512 may be considered proprietary.

The UE training component 140 may provide Vᵢₙ 512 to the encoder 514 to generate an encoded intermediate vector set (zₑ) 516, which may also be referred to as a latent vector or compressed vector. The UE training component 140 may provide the zₑ 516 to a UE decoder 518. The UE decoder 518 may be a machine-learning model such as a neural network used for training purposes and may not actually be deployed to a UE 104 because the UE 104 does not need to decode uplink control information. The UE decoder 518 may generate an output vector set (Vₒᵤₜ) 520, which should ideally be the same as Vᵢₙ 512, however, some error is expected. The loss function 522 may calculate the error between Vᵢₙ 512 and Vₒᵤₜ 520. The loss function 522 may, for example, used to calculate gradients, which can be used to update weights within the encoder 514 and the UE decoder 518.

The UE-associated entities 508 may transmit a sequential training dataset 524 to the base station-associated entity 506. The sequential training dataset 524 may include zₑ 516 and one of Vᵢₙ 512 or Vₒᵤₜ 520. At block 530, the base station-associated entity 506 may aggregate the sequential training datasets 524 to form a training set including intermediate vectors (z) 532 and Vᵢₙ 512 or Vₒᵤₜ 520.

At block 540, the base station-associated entity 506 may train a base station decoder 542. The block 540 may include providing z 532 to the base station decoder 542. The base station decoder 542 may be a machine-learning model such as a neural network trained to decode encoded vectors into uplink control information. The base station decoder 542 may generate an output vector set (Vout,BS) 544, which ideally should be the same as Vin 512 or Vout 520. The loss function 546 may calculate the error of Vout, BS 544 based on either Vin 512 or Vout 520, depending on the contents of the sequential training dataset 524. The loss function 546 may determine a gradient to update the weights of the base station decoder 542. Unlike the UE decoder 518, the base station decoder 542 may be deployed to a base station 102. The sequential training allows the encoder 514 and the base station decoder 542 to be trained by a respective entity without being shared.

In an aspect, a separate training framework may include a procedure for training a base station decoder that works with multiple UE encoders. In a practical system, the UE quantizes the latent vector (e.g., ze), before transmitting it to the base station, in order to convey the latent vector only using a finite number of bits. Either scalar or vector quantization may be applied to the latent vectors. Quantization achieved by using codebooks that contains a finite number of scalars or vectors.

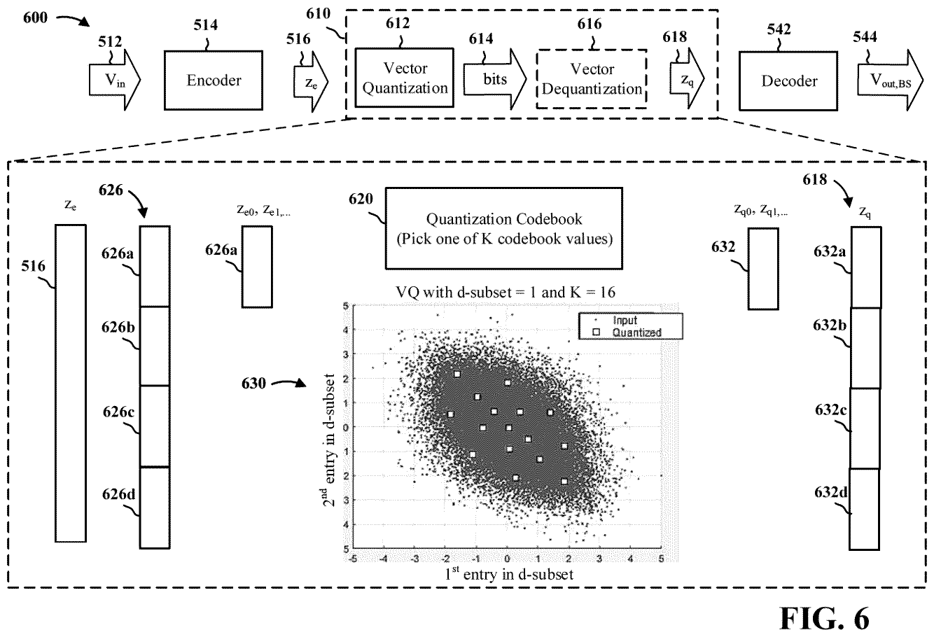

FIG. 6 is a diagram of an example quantization and dequantization procedure 610, which may be used within an encoding/decoding procedure 600. The procedure 600 may start with providing Vᵢₙ 512 to an encoder 514 to generate zₑ 516. The quantization and dequantization procedure 610 may be performed on zₑ 516. For example, during operation, zₑ 516 may be quantized by vector quantization 612 to generate an encoded and quantized intermediate vector set (z_{q}) 618, which may be represented by bits 614 for transmission. The bits 614 may be transmitted by the UE 104 to the base station 102. The base station 102 may optionally perform vector dequantization 616 to generate encoded and quantized intermediate vector set (z_{q}) 618. For instance, the vector dequantization 616 may utilize a reconstruction codebook to convert bits to quantized vectors. The base station 102 may provide z_{q} 618 to the BS decoder 542 to generate V_{out,BS} 544. In some implementations, the BS decoder 542 may be trained to operate directly on the bits 614.

In an aspect, the quantization procedure 610 may further reduce a size of the zₑ 516 for transmission using a quantization codebook 620. The quantization codebook 620 may map vectors to finite real values or a stream of bits. For example, the quantization codebook 620 may map sub-vectors of, for example, size 2 or 4 where each vector entry is represented by 2 bits. Each entry in the quantization codebook 620 is a vector of size d-subset. zₑ 516 may be larger than Each entry in codebook is a vector of size d-subset. The vector quantization 612 may divide zₑ 516 into sub-vectors 626 (e.g., sub-vectors 626a, 626b, 626c, 626d) of size d-subset (e.g., 2 or 4). The vector quantization 612 may use the quantization codebook 620 to map each sub-vector 626 to a finite real value (e.g., K) or bit value. For instance, in the chart 630, the quantization codebook 620 may define the quantized values. The vector quantization 612 may map each sub-vector 626 to the closest quantized value. Each quantized value may be associated with a stream of bits 614. At the base station, the encoded vector may be recreated by mapping the bits 614 to sub-vectors 632 (e.g., sub-vectors 632a, 632b, 632c, 632d) using a reconstruction codebook (which may be the same or the inverse of the quantization codebook 620) and assembling multiple sub-vectors into z_{q} 618.

In an aspect, training the quantization codebook 620 may involve selecting the quantized values based on a training set of input values. The quantized values may be the values that minimize average distance from the input values. For example, the quantized values may be selected by clustering to find quantized values that are close to many input values. Because the quantization may depend on the output of the encoder 514 and/or affect the decoder 542, training of the quantization may be done jointly with training the encoder or decoder. That is, the selected quantized values may be updated whenever the encoder or decoder weights are updated. The quantization codebook 620 may be shared between a UE-associated entity 508 and a base station-associated entity 506.

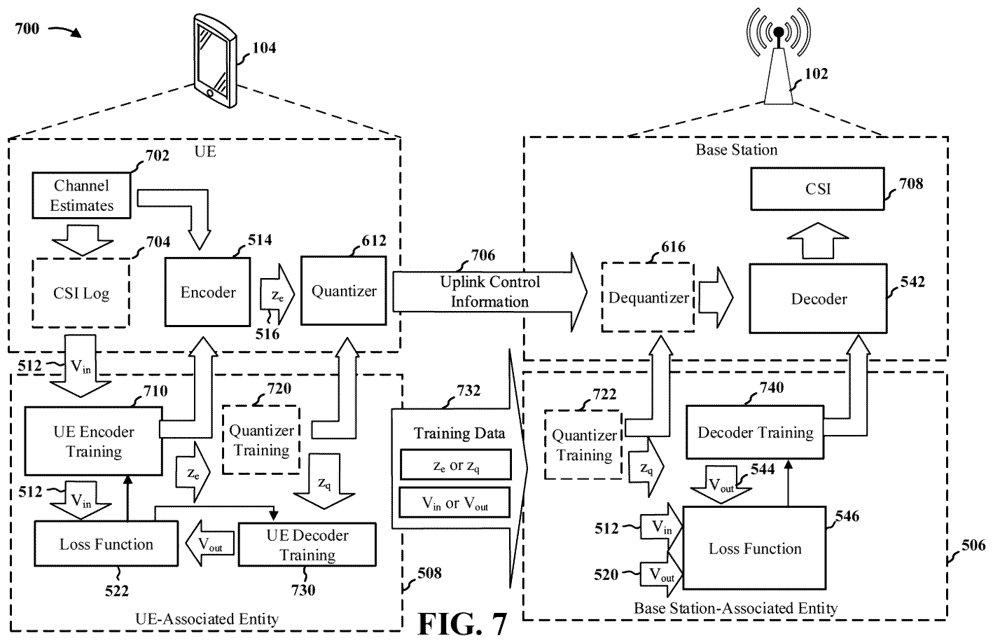

FIG. 7 is a diagram of an example sequential training system 700 for encoders 514 and decoders 542 with quantization. For optimum performance, the quantization codebooks should be learned together with the neural networks for encoders and decoders, in an end-to-end learning. For example, an encoder 514 and quantization codebook 620 may be trained at a UE-associated entity 508 and deployed to the UE 104, and a decoder 542 may be trained at a base station-associated entity 506 and deployed to the base station 102. As another example, a UE-associated entity 508 may train the encoder 514 and deploy the encoder 514 to the UE 104, and a base station-associated entity 506 may train decoder 542 and quantization codebook 620 for deployment to the base station 102. The trained quantization codebook 620 may be shared between the UE-associated entity 508 and the base station-associated entity 506.

During training at the UE-associated entity 508, the UE-associated entity 508 may receive the Vᵢₙ 512 (e.g., from one or more UEs 104 or a synthesized source). UE encoder training 710 may train the neural network for the encoder 514. In some implementations, the quantizer training 720 may be performed on the ze 516. The quantizer training 720 may output z_{q} 618 to the decoder training 730. The decoder training 730 may train a UE decoder, which is used only for training. The decoder training 730 may output Vₒᵤₜ 520 to the loss function 522. The loss function may calculate the gradient between Vᵢₙ 512 and Vₒᵤₜ 520, and use the gradient to adjust the weights in the UE encoder training 710 and the UE decoder training 730. The UE encoder training 710 may deploy the trained UE encoder to the encoder 514 at a UE 104. The quantizer training 720 may deploy the trained quantizer to the quantizer 612 at the UE 104. The quantizer training 720 may also share the quantization codebook 620 to the base station-associated entity 506. The UE-associated entity 508 may share a training dataset 732. The training dataset 732 may include one of the zₑ 516 or z_{q} 618 to the base station-associated entity 506. The training dataset 732 may include one of the Vᵢₙ 512 or Vₒᵤₜ 520.

During training at the base station-associated entity 506, the base station-associated entity 506 may optionally perform quantizer training 722. For example, the quantizer training 722 may receive the zₑ 516 and train the quantization codebook 620 to produce z_{q} 618. The quantizer training 722 may share the quantization codebook 620 back to the UE-associated entity 508. The decoder training 740 may be performed on the z_{q} 618 received in the training dataset 732 or produced by the quantizer training 722. The decoder training 740 may train a neural network to generate V_{out,BS} 544. The loss function 546 may compare the received Vᵢₙ 512 or Vₒᵤₜ 520 with the V_{out,BS} 544 to determine gradients and update the weights of the neural network. The base station-associated entity 506 may output the trained decoder to the base station 102 for use as decoder 542.

In operation (e.g., during an inference phase), the UE 104 may obtain channel estimates 702 (e.g., based on measurements of reference signals). The UE 104 may provide the channel estimates to the encoder 514, which may generate an encoded intermediate vector (zₑ) 516. In some implementations, the UE 104 may also store the channel estimates 702 as a CSI log 704, which may be used as training data (e.g., Vᵢₙ) for the encoder training. The quantizer 612 may quantize the zₑ 516 to generate a bitstream (e.g., based on the quantization codebook 620) for transmission as uplink control information 706. At the base station 102, the dequantizer 616 may convert the bits 614 back to an intermediate coded and quantized vector (z_{q}). The decoder 542 may decode z_{q} to obtain V_{out,BS}, which may be interpreted as, for example, CSI 708.

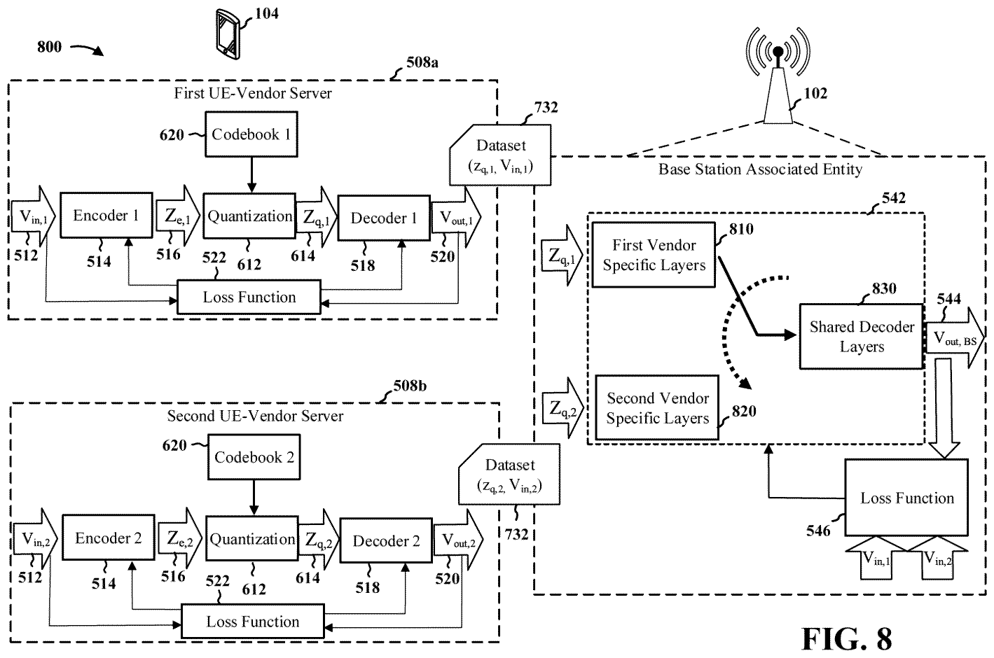

FIG. 8 is a diagram of an example multi-vendor sequential training system 800 for encoders and decoders with quantization training at UE associated entities. Each UE-associated entity 508 may separately train an encoder 514, a quantization codebook 620, and a UE decoder 518. Each UE-associated entity 508 may generate a dataset 732 for transmission to the base station-associated entity 506.

In an aspect, the design of the multi-vendor sequential training system 800 may depend on how much information is shared between the UE-associated entity 508 and the base station-associated entity 506. Some information such as a payload size of z (number of bits and z-dimension) are known to both entities, for example, based on a standard or regulation. In a first option, there may be no agreement between UE-associated entity 508 and the base station-associated entity 506 related to quantization. The UE-associated entity 508 can train its encoder and decoder pair with scalar or vector quantization. The UE-associated entity 508 can share dataset 732 including z_{q} and one of Vᵢₙ or Vₒᵤₜ with the base station-associated entity 506. By analyzing the dataset 732, base station-associated entity 506 can figure out that z-space is quantized and no quantization is needed when training the decoder. Alternatively, base station-associated entity 506 can train additional quantization as part of decoder; however, two stage quantization may not be desirable (e.g., due to complexity).

In a second option, the UE-associated entity 508 and the base station-associated entity 506 agree that quantization is done at UE side, however, the quantization method selection is up to UE-associated entity 508. The UE-associated entity 508 selects the quantization method (scalar vs vector quantization) and the quantization parameters. The base station-associated entity 506 does not need to know details of the quantization method. The UE-associated entity 508 can share a dataset 732 including z_{q} and one of Vᵢₙ or Vₒᵤₜ with base station-associated entity 506. The base station-associated entity 506 may train the BS decoder 542 without quantization.

In a third option, the UE-associated entity 508 and the base station-associated entity 506 agree on the exact quantization method used in training at UE-associated entity 508. The UE-associated entity 508 a dataset 732 including z_{q} and one of Vᵢₙ or Vₒᵤₜ with base station-associated entity 506. The base station-associated entity 506 may train the BS decoder 542 without quantization.

In an aspect, the BS decoder 542 may be a multi-UE decoder including first vendor specific layers 810 (e.g., corresponding to first UE-vendor server 508a) and second vendor specific layers 820 (e.g., corresponding to second UE-vendor server 508b). The BS decoder 542 also includes shared decoder layers 830. The BS decoder 542 may output a V_{out,BS} 544 to the loss function 546. The loss function 546 may compare the V_{out,BS} 544 to the Vᵢₙ 512 for each UE-associated entity 508 to determine a gradient for adjusting the weights of the first vendor specific layers 810, the second vendor specific layers 820, and/or the shared decoder layers 830.

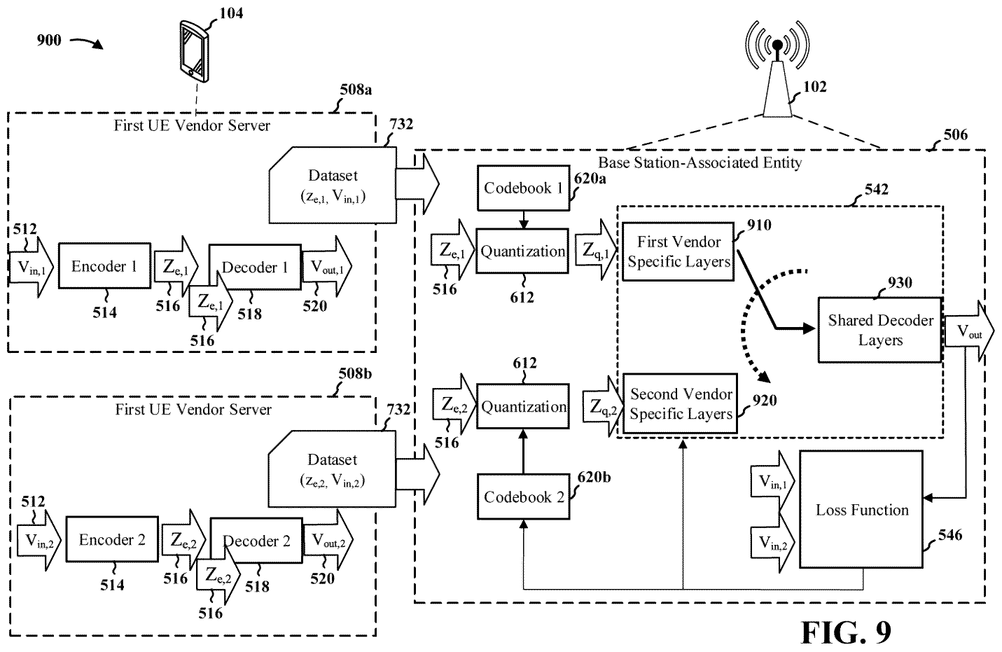

FIG. 9 is a diagram of an example multi-vendor sequential training system 900 for encoders and decoders with quantization training at a base station-associated entity 506. Each UE-associated entity 508 may separately train an encoder 514 and a UE decoder 518. Each UE-associated entity 508 may generate a dataset 732 for transmission to the base station-associated entity 506. The base station-associated entity 506 may train a quantization codebook 620 and a BS decoder 542.

In an aspect, the design of the multi-vendor sequential training system 900 may depend on how much information is shared between the UE-associated entity 508 and the base station-associated entity 506. In a first option, the UE-associated entity 508 and the base station-associated entity 506 agree that the quantization codebook 620 will be trained with the BS decoder 542 at the base station-associated entity 506. In some implementation, the UE-associated entity 508 can train the encoder 514 and UE decoder 518 pair without VQ and share a dataset 732 including zₑ and one of Vᵢₙ or Vₒᵤₜ with the base station-associated entity 506. The base station-associated entity 506 can include quantizer training 720 as part of BS decoder 542. Alternatively, the UE-associated entity 508 can train its encoder and decoder pair with scalar or vector quantization, and share a dataset 732 including zₑ or z_{y} and one of Vᵢₙ or Vₒᵤₜ. The base station-associated entity 506 may train a common quantization codebook 620 for both the UE 104 and the base station 102 based on zₑ. The base station-associated entity 506 may share the quantization codebook 620 back to the UE-associated entity 508 for use at the UE 104. In some implementations, where the base station-associated entity 506 receives only z_{q}, the base station-associated entity 506 may train an additional quantization codebook 620 based on z_{q}, which may be undesirable, e.g., due to complexity.

In a second option, the UE-associated entity 508 and the base station-associated entity 506 agree on the exact quantization method used in training at the UE-associated entity 508. The UE-associated entity 508 can train its encoder 514 and decoder 518 pair without quantization and share zₑ and one of Vᵢₙ or Vₒᵤₜ with the base station-associated entity 506. Alternatively, the UE-associated entity 508 can train its encoder 514 and decoder 518 pair with the agreed quantization method and share zₑ and one of Vᵢₙ or Vₒᵤₜ with the base station-associated entity 506. In either case, the base station-associated entity 506 includes quantizer training as part of BS decoder 542.

In an aspect, the base station-associated entity 506 may train vendor-specific quantization codebooks 620a and 620b along with BS decoder 542. For example, the base station-associated entity 506 may receive the respective Ze 516 in the dataset 732 and train the vendor specific quantization codebook 620. A respective quantizer 612 may output a vendor specific z_{q} to the BS decoder 542. The BS decoder 542 may be a multi-UE decoder including first vendor specific layers 910 (e.g., corresponding to first UE-vendor server 508a) and second vendor specific layers 920 (e.g., corresponding to second UE-vendor server 508b). The BS decoder 542 also includes shared decoder layers 930. The BS decoder 542 may output a V_{out,BS} 544 to the loss function 546. The loss function 546 may compare the V_{out,BS} 544 to the Vᵢₙ 512 for each UE-associated entity 508 to determine a gradient for adjusting the weights of the first vendor specific layers 910, the second vendor specific layers 920, and/or the shared decoder layers 930. Further, in some implementations, the loss function 546 may adjust the vendor-specific quantization codebooks 620a and 620b.

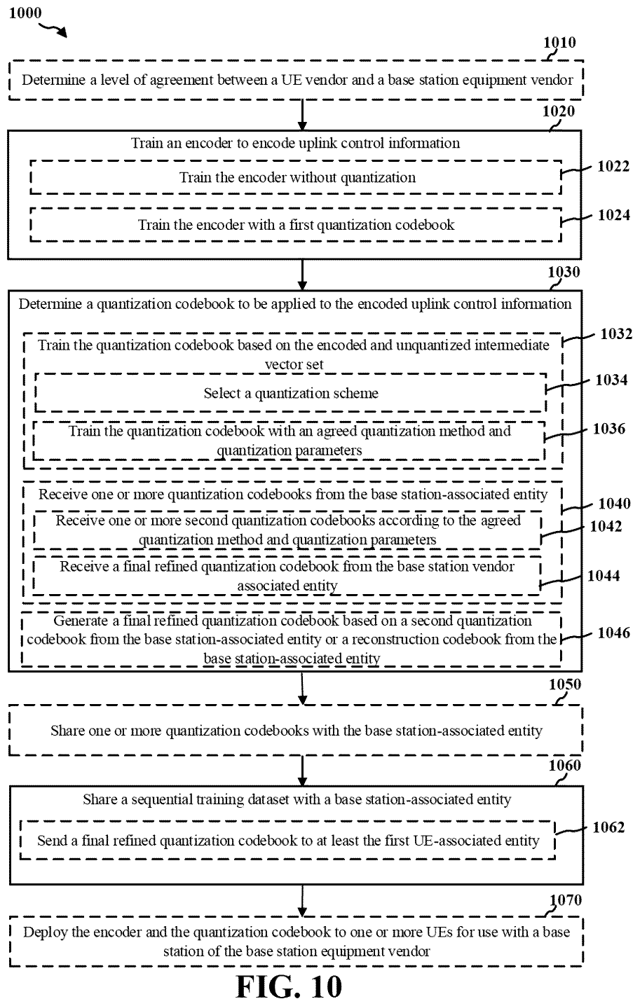

FIG. 10 is a flowchart of an example method 1000 for a UE-associated entity 508 to train an encoder and quantizer. The method 1000 may be performed by a UE-associated entity 508 (such as a UE-vendor server 108 or the UE 104, which may include the memory 360 and which may be the entire UE 104 or a component of the UE 104 such as the UE training component 140, Tx processor 368, the Rx processor 356, or the controller/processor 359). The method 1000 may be performed by the UE training component 140 in communication with the BS training component 120 of one or more base station related entities 506. Optional blocks are shown with dashed lines.

At block 1010, the method 1000 optionally includes determining a level of agreement between a UE vendor and a base station equipment vendor. In some implementations, for example, the UE 104, the Rx processor 356, or the controller/processor 359 may execute the UE training component 140 or the sharing component 146 to determine the level of agreement between the UE vendor and the base station equipment vendor. Accordingly, the UE 104, the Rx processor 356, or the controller/processor 359 executing the UE training component 140 or the sharing component 146 may provide means for determining a level of agreement between a UE vendor and a base station equipment vendor.

At block 1020, the method 1000 includes training an encoder to encode uplink control information. In some implementations, for example, the UE 104, the TX processor 368, or the controller/processor 359 may execute the UE training component 140 or the encoder training component 142 to train the encoder 514 to encode uplink control information. In some implementations, training the encoder is based on a loss function 522 between the input vector set (e.g., Vᵢₙ 512) and an output vector set (e.g., Vₒᵤₜ) from a UE decoder 518. In some implementations, at sub-block 1022, the block 1020 may optionally include training the encoder without quantization. In some implementations, at sub-block 1024, the block 1020 may include training the encoder with a first quantization codebook. For instance, the first quantization codebook may be trained at the UE-associated entity 508. Accordingly, the UE 104, the TX processor 368, or the controller/processor 359 executing the UE training component 140 or the encoder training component 142 may provide means for training an encoder to encode uplink control information.

At block 1030, the method 1000 may optionally include determining a quantization codebook to be applied to the encoded uplink control information. In some implementations, for example, the UE 104, the TX processor 368, or the controller/processor 359 may execute the UE training component 140 or the quantizer training component 144 to determine the quantization codebook 620 to be applied to the encoded uplink control information. In some implementations, for example, at sub-block 1032, the block 1030 may optionally include training the quantization codebook based on the encoded and unquantized intermediate vector set. For instance, at sub-block 1034, the sub-block 1032 may optionally include selecting a quantization scheme (e.g., when there is no agreement between the UE vendor and the base station vendor). Example quantization schemes may include scalar quantization or vector quantization. Parameters for vector quantization may include subset size and bit size. As another example, at sub-block 1036, the sub-block 1032 may optionally include training the quantization codebook with an agreed quantization method and quantization parameters.

In some implementations, at sub-block 1040, the block 1030 may optionally include receiving one or more quantization codebooks from the base station-associated entity 506. For instance, at sub-block 1042, the sub-block 1040 may optionally include receiving one or more second quantization codebooks according to the agreed quantization method and quantization parameters. The one or more second quantization codebooks may be trained by the base station-associated entity 506 and replace a first quantization codebook trained at the UE-associated entity. As another example, at sub-block 1044, the sub-block 1040 may optionally include receiving a final refined quantization codebook from the base station vendor-associated entity. The final refined quantization codebook may be trained by the base station-associated entity 506 based on a first quantization codebook trained at the UE-associated entity (e.g., in sub-block 1032).

In some implementations, at sub-block 1046, the block 1030 may optionally include generating a final refined quantization codebook based on a second quantization codebook from the base station-associated entity or a reconstruction codebook from the base station-associated entity. For instance, the second quantization codebook or the reconstruction codebook may be received in sub-block 1040. The quantizer training component 144 may further train the received codebook based on the encoder 514.

In view of the foregoing, the UE 104, the TX processor 368, or the controller/processor 359 executing the UE training component 140 or the quantizer training component 144 may provide means for determining a quantization codebook to be applied to the encoded uplink control information.

At block 1050, the method 1000 may optionally include sharing one or more quantization codebooks with the base station-associated entity. In some implementations, for example, the UE 104, the Rx processor 368, or the controller/processor 359 may execute the UE training component 140 or the sharing component 146 to share one or more quantization codebooks 620 with the base station-associated entity 506. Accordingly, the UE 104, the Tx processor 368, or the controller/processor 359 executing the UE training component 140 or the sharing component 146 may provide means for sharing one or more quantization codebooks with the base station-associated entity.

At block 1060, the method 1000 includes sharing a sequential training dataset with a base station-associated entity. In some implementations, for example, the UE 104, the Rx processor 368, or the controller/processor 359 may execute the UE training component 140 or the sharing component 146 to share the sequential training dataset 732 with the base station-associated entity 506. The sequential training dataset 732 includes one of an input vector set or an output vector set; and one of an encoded and unquantized intermediate vector set (e.g., zₑ 516) or an encoded and quantized intermediate vector set (e.g., z_{q} 618). Accordingly, the UE 104, the Tx processor 368, or the controller/processor 359 executing the UE training component 140 or the sharing component 146 may provide means for sharing a sequential training dataset with a base station-associated entity.

At block 1070, the method 1000 may optionally include deploying the encoder and the quantization codebook to one or more UEs for use with a base station of the base station equipment vendor. In some implementations, for example, the UE 104, the Tx processor 368, or the controller/processor 359 may execute the UE training component 140 or the deployment component 148 to deploy the encoder 514 and the quantization codebook 620 to one or more UEs 104 for use with a base station 102 of the base station equipment vendor. Accordingly, the UE 104, the Tx processor 368, or the controller/processor 359 executing the UE training component 140 or the deployment component 148 may provide means for deploying the encoder and the quantization codebook to one or more UEs for use with a base station of the base station equipment vendor.

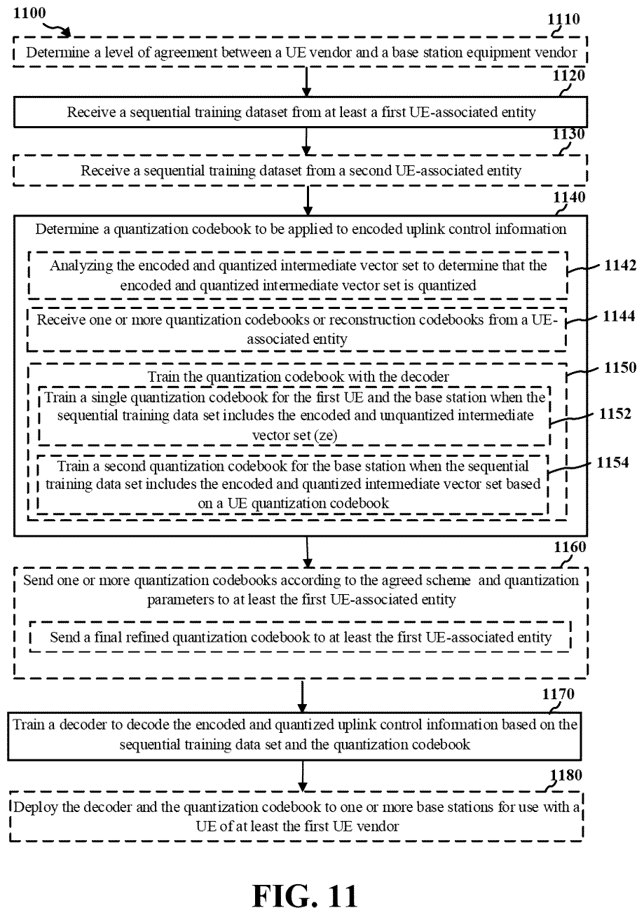

FIG. 11 is a flowchart of an example method 1100 for a base station-associated entity 506 to train a decoder and quantization codebook. The method 1100 may be performed by a base station-associated entity 506 (such as the base station server 106 or the base station 102, which may include the memory 376 and which may be the entire base station 102 or a component of the base station 102 such as the BS training component 120, Tx processor 316, the Rx processor 370, or the controller/processor 375). The method 1100 may be performed by the BS training component 120 in communication with the UE training component 140 of one or more UE-associated entities 508. Optional blocks are shown with dashed lines.

At block 1110, the method 1100 may optionally include determining a level of agreement between a UE vendor and a base station equipment vendor. In some implementations, for example, the base station 102, the Tx processor 316, or the controller/processor 375 may execute the BS training component 120 to determine a level of agreement between the UE vendor and the base station equipment vendor. Accordingly, the base station 102, the Tx processor 316, or the controller/processor 375 executing the BS training component 120 or may provide means for determining a level of agreement between a UE vendor and a base station equipment vendor.

At block 1120, the method 1100 includes receiving a sequential training dataset from at least a first UE-associated entity. In some implementations, for example, the base station 102, the Rx processor 370, or the controller/processor 375 may execute the BS training component 120 or the dataset receiving component 122 to receive a sequential training dataset 732 from at least a first UE-associated entity 508 (e.g., UE-vendor server 508a). The sequential training dataset 732 includes one of an input vector set or an output vector set; and one of an encoded and unquantized intermediate vector set (e.g., zₑ 516) or an encoded and quantized intermediate vector set (e.g., z_{q} 618). In some implementations, at block 1130, the method 1100 may optionally include receiving a sequential training dataset from a second UE-associated entity 508 (e.g., second UE-vendor server 508b). Accordingly, the base station 102, the Rx processor 370, or the controller/processor 375 executing the BS training component 120 or the dataset receiving component 122 may provide means for receiving a sequential training dataset from at least a first UE-associated entity.

At block 1140, the method 1100 includes determining a quantization codebook to be applied to encoded uplink control information. In some implementations, for example, the base station 102, the Rx processor 370, or the controller/processor 375 may execute the BS training component 120 or the quantizer training component 124 to determine a quantization codebook to be applied to encoded uplink control information.

For example, in some implementations, at sub-block 1142, the block 1140 may optionally include analyzing the encoded and quantized intermediate vector set to determine that the encoded and quantized intermediate vector set is quantized. For instance, the encoded and quantized intermediate vector set may include a finite number of values. The quantizer training component 124 may generate a codebook based on the finite number of values.

In some implementations, at sub-block 1144, the block 1140 may optionally include receiving one or more quantization codebooks 620 or reconstruction codebooks from a UE-associated entity 508. For example, the quantization codebook 620 may be trained at the UE-associated entity 508.

In some implementations, at sub-block 1150, the block 1140 may optionally include training the quantization codebook 620 with the decoder 542. For instance, at sub-block 1152, the quantizer training component 124 may optionally train a single quantization codebook 620 for the first UE and the base station when the sequential training dataset 732 includes the encoded and unquantized intermediate vector set (e.g., zₑ 514). As another example, at sub-block 1154, the sub-block 1150 may optionally include training a second quantization codebook 620 for the base station when the sequential training dataset 732 includes the encoded and quantized intermediate vector set (e.g., z_{q} 618) based on a UE quantization codebook. That is, the quantizer training component 124 may train a second level of quantization.

In view of the foregoing, the base station 102, the Rx processor 370, or the controller/processor 375 executing the BS training component 120 or the quantizer training component 124 may provide means for determining a quantization codebook to be applied to encoded uplink control information.

At block 1160, the method 1100 may optionally include sending one or more quantization codebooks according to the agreed scheme and quantization parameters to at least the first UE-associated entity. In some implementations, for example, the base station 102, the Tx processor 316, or the controller/processor 375 may execute the BS training component 120 to send one or more quantization codebooks according to the agreed scheme and quantization parameters to at least the first UE-associated entity. For example, the one or more quantization codebooks may be trained in sub-block 1150. In some implementations, at sub-block 1062, the block 1060 may optionally include sending a final refined quantization codebook to at least the first UE-associated entity. For example, the final refined quantization codebook may be refined based on a quantization codebook received in sub-block 1144. Accordingly, the base station 102, the Tx processor 316, the Rx processor 370, or the controller/processor 375 executing the BS training component 120 may provide means for sending one or more quantization codebooks according to the agreed scheme and quantization parameters to at least the first UE-associated entity.

At block 1170, the method 1100 includes training a decoder to decode the encoded and quantized uplink control information based on the sequential training dataset and the quantization codebook. In some implementations, for example, the base station 102, the Rx processor 370, or the controller/processor 375 may execute the BS training component 120 or the decoder training component 126 to train the decoder 542 to decode the encoded and quantized uplink control information based on the sequential training dataset 732 and the quantization codebook 620. In some implementations, training the decoder is based on a loss function 546 between the input vector set (e.g., Vᵢₙ 512) or the output vector set (e.g., Vₒᵤₜ) and an output vector set (e.g., V_{out,BS} 544) from the decoder 542 applied to the encoded and unquantized intermediate vector set (e.g., zₑ 516) or the encoded and quantized intermediate vector set (e.g., z_{q} 618). Accordingly, the base station 102, the Rx processor 370, or the controller/processor 375 executing the BS training component 120 or the decoder training component 126 may provide means for training a decoder to decode the encoded and quantized uplink control information based on the sequential training dataset and the quantization codebook.

At block 1180, the method 1100 may optionally include deploying the decoder and the quantization codebook to one or more base stations for use with a UE of at least the first UE vendor. In some implementations, for example, the base station 102, the Tx processor 316, or the controller/processor 375 may execute the BS training component 120 to deploy the decoder 542 and the quantization codebook 620 (e.g., for dequantizer 616) to one or more base stations for use with a UE of at least the first UE vendor. Accordingly, the base station 102, the Tx processor 316, or the controller/processor 375 executing the BS training component 120 may provide means for deploying the decoder and the quantization codebook to one or more base stations for use with a UE of at least the first UE vendor.

The following numbered clauses provide an overview of aspects of the present disclosure:
1. A method performed at a UE-associated entity, comprising:
   training an encoder to encode uplink control information;
   determining a quantization codebook to be applied to the encoded uplink control information; and
   sharing a sequential training dataset with a base station-associated entity, the sequential training dataset including:
      one of an input vector set or an output vector set; and
      one of an encoded and unquantized intermediate vector set or an encoded and quantized intermediate vector set.
2. The method of clause 1, further comprising determining a level of agreement between a UE vendor and a base station equipment vendor, wherein the training the encoder, the determining the quantization codebook, or a content of the sequential training dataset is based on the level of agreement.
3. The method of clause 2, further comprising deploying the encoder and the quantization codebook to one or more UEs for use with a base station of a base station equipment vendor.
4. The method of any of clauses 1-3, wherein training the encoder is based on a loss function between the input vector set and an output vector set from a UE decoder.
5. The method of any of clauses 1-4, wherein determining the quantization codebook comprises training the quantization codebook at the UE-associated entity based on the encoded and unquantized intermediate vector set, wherein the sequential training dataset includes the encoded and quantized intermediate vector set.
6. The method of clause 5, further comprising sharing one or more quantization codebooks with the base station-associated entity.
7. The method of clause 5 or 6, wherein training the quantization codebook at the UE-associated entity based on the encoded and unquantized intermediate vector set comprises selecting a quantization scheme.
8. The method of clause 5 or 6, wherein training the quantization codebook at the UE-associated entity based on the encoded and unquantized intermediate vector set comprises training the quantization codebook with an agreed quantization method and quantization parameters.
9. The method of any of clauses 1-4, wherein determining the quantization codebook comprises receiving one or more quantization codebooks from the base station-associated entity, wherein training, at the UE-associated entity, an encoder to encode uplink control information comprises training the encoder without quantization.
10. The method any of clauses 1-4, wherein training the encoder to encode uplink control information comprises training the encoder with a first quantization codebook, and wherein determining the quantization codebook comprises receiving a second quantization codebook from the base station-associated entity.
11. The method any of clauses 1-4, wherein determining the quantization codebook to be applied to the encoded uplink control information comprises receiving one or more quantization codebooks according to an agreed quantization method, wherein training, at the UE-associated entity, an encoder to encode uplink control information comprises training the encoder without quantization, wherein a content of the training dataset includes the encoded and unquantized intermediate vector set.
12. The method of any of clauses 1-4, wherein training the encoder to encode uplink control information comprises training the encoder with first quantization codebook based on an agreed quantization method and quantization parameters, wherein a content of the training dataset includes the encoded and unquantized intermediate vector set, and wherein determining the quantization codebook to be applied to the encoded uplink control information comprises receiving one or more second quantization codebooks according to the agreed quantization method and quantization parameters.
13. The method of any of clauses 1-4, wherein determining the quantization codebook comprises:
   training the quantization codebook at the UE-associated entity based on the encoded and unquantized intermediate vector set; and
   receiving a final refined quantization codebook from the base station-associated entity.
14. The method of any of clauses 1-4, wherein determining the quantization codebook to be applied to the encoded uplink control information comprises:
   training the quantization codebook at the UE-associated entity based on the encoded and unquantized intermediate vector set; and
   generating a final refined quantization codebook based on a second quantization codebook from the base station-associated entity or a reconstruction codebook from the base station-associated entity.
15. A method performed at a base station-associated entity, comprising:
   receiving a sequential training dataset from at least a first UE-associated entity, the sequential training dataset including:
      one of an input vector set or an output vector set; and
      one of an encoded and unquantized intermediate vector set or an encoded and quantized intermediate vector set;
   determining a quantization codebook to be applied to encoded and quantized uplink control information; and
   training a decoder to decode the encoded and quantized uplink control information based on the sequential training dataset and the quantization codebook.
16. The method of clause 15, further comprising determining a level of agreement between a first UE vendor and a base station equipment vendor, wherein the training the decoder, the determining the quantization codebook, or a content of the sequential training dataset is based on the level of agreement.
17. The method of clause 16, further comprising deploying the decoder and the quantization codebook to one or more base stations for use with a UE of the first UE vendor.
18. The method of any of clauses 15-17, wherein training the decoder is based on a loss function between the input vector set or the output vector set and an output vector set from the decoder applied to the encoded and unquantized intermediate vector set or the encoded and quantized intermediate vector set.
19. The method of any of clauses 15-18, further comprising receiving a sequential training dataset from a second UE-associated entity, and wherein the decoder includes first vendor specific layers, second vendor specific layers, and shared decoder layers.
20. The method of any of clauses 15-19, wherein the quantizer is trained at the UE-associated entity, wherein the sequential training dataset includes the encoded and quantized intermediate vector set.
21. The method of clause 20, wherein determining the quantization codebook comprises analyzing the encoded and quantized intermediate vector set to determine that the encoded and quantized intermediate vector set is quantized.
22. The method of clause 20, wherein the encoded and quantized intermediate vector set is quantized based on an agreed quantization method and quantization parameters.
23. The method of clause 20, further comprising receiving one or more quantization codebooks or reconstruction codebooks from a UE-associated entity.
24. The method of any of clauses 15-19, wherein determining the quantization codebook to be applied to encoded and quantized uplink control information comprises training the quantization codebook with the decoder.
25. The method of clause 24, wherein training the quantizer with the decoder is based on an agreed quantization scheme and quantization parameters, wherein a content of the training dataset includes the encoded and unquantized intermediate vector set.
26 The method of clause 25, further comprising sending one or more quantization codebooks according to the agreed scheme and quantization parameters to at least the first UE-associated entity.
27. The method of any of clauses 15-19, wherein determining a quantizer to be applied to encoded and quantized uplink control information comprises:
   training the quantization codebook at the base station-associated entity based on the encoded and unquantized intermediate vector set;
   receiving one or more quantization codebooks or reconstruction codebooks from at least the first UE-associated entity; and
   sending a final refined quantization codebook to at least the first UE-associated entity.
28. The method of any of clauses 15-19, wherein determining a quantizer to be applied to encoded and quantized uplink control information comprises:
   training the quantizer at the base station-associated entity based on the encoded and unquantized intermediate vector set;
   sending one or more quantization codebooks or reconstruction codebooks to at least the first UE-associated entity; and
   receive a final refined quantization codebook from at least the first UE-associated entity.
29. A UE-associated entity, comprising:
   a memory storing computer-executable instructions; and
   a processor configured to execute the instructions and cause the UE-associated entity to perform the method of any of clauses 1-14.
30. A base station, comprising:
   a memory storing computer-executable instructions; and
   a processor configured to execute the instructions and cause the base station to perform the method of any of clauses 15-28.
31. An apparatus for wireless communications, comprising means for performing a method in accordance with any one of examples 1-14.
32. An apparatus for wireless communications, comprising means for performing a method in accordance with any one of examples 15-28.
33. A non-transitory computer-readable medium comprising instructions that, when executed by an apparatus, causes the apparatus to perform a method in accordance with any one of examples 1-14.
34. A non-transitory computer-readable medium comprising instructions that, when executed by an apparatus, cause the apparatus to perform a method in accordance with any one of examples 15-28.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “clement,” “device,” and the like may not be a substitute for the word “means.” As such, no claim element is to be construed as a means plus function unless the element is expressly recited using the phrase “means for.”

1. A user equipment (UE)-associated entity, comprising:
at least one memory; and
at least one processor coupled to the at least one memory, the at least one processor configured to:
train an encoder to encode uplink control information;
determine a quantization codebook to be applied to the encoded uplink control information; and
share a sequential training dataset with a base station-associated entity, the sequential training dataset including:
one of an input vector set or an output vector set; and
one of an encoded and unquantized intermediate vector set or an encoded and quantized intermediate vector set.

2. The UE-associated entity of claim 1, wherein the at least one processor is configured to determine a level of agreement between a UE vendor and a base station equipment vendor, wherein the at least one processor is configured to train the encoder, determine the quantization codebook, or a content of the sequential training dataset based on the level of agreement.

3. The UE-associated entity of claim 2, wherein the at least one processor is configured to deploy the encoder and the quantization codebook to one or more UEs for use with a base station of a base station equipment vendor.

4. The UE-associated entity of claim 1, wherein the at least one processor is configured to train the encoder based on a loss function between the input vector set and an output vector set from a UE decoder.

5. The UE-associated entity of claim 1, wherein to determine the quantization codebook, the at least one processor is configured to train the quantization codebook at the UE-associated entity based on the encoded and unquantized intermediate vector set, wherein the sequential training dataset includes the encoded and quantized intermediate vector set.

6. The UE-associated entity of claim 5, wherein the at least one processor is further configured to share one or more quantization codebooks with the base station-associated entity.

7. The UE-associated entity of claim 5, wherein to train the quantization codebook at the UE-associated entity based on the encoded and unquantized intermediate vector set, the at least one processor is configured to select a quantization scheme.

8. The UE-associated entity of claim 5, wherein to train the quantization codebook at the UE-associated entity based on the encoded and unquantized intermediate vector set, the at least one processor is configured to train the quantization codebook with an agreed quantization method and quantization parameters.

9. The UE-associated entity of claim 1, wherein to determine the quantization codebook, the at least one processor is configured to receive one or more quantization codebooks from the base station-associated entity, wherein to train, at the UE-associated entity, the at least one processor comprises an encoder to encode uplink control information, the encoder trained without quantization.

10. The UE-associated entity of claim 1, wherein to train the encoder to encode uplink control information, the at least one processor is configured to train the encoder with a first quantization codebook, and wherein to determine the quantization codebook, the at least one processor is configured to receive a second quantization codebook from the base station-associated entity.

11. The UE-associated entity of claim 1, wherein to determine the quantization codebook to be applied to the encoded uplink control information, the at least one processor is configured to receive one or more quantization codebooks according to an agreed quantization method, wherein to train, at the UE-associated entity, the at least one processor comprises an encoder to encode uplink control information wherein the encoder is trained without quantization, wherein a content of the training dataset includes the encoded and unquantized intermediate vector set.

12. The UE-associated entity of claim 1, wherein to train the encoder to encode uplink control information, the at least one processor is configured to training the encoder with first quantization codebook based on an agreed quantization method and quantization parameters, wherein a content of the training dataset includes the encoded and unquantized intermediate vector set, and wherein to determine the quantization codebook to be applied to the encoded uplink control information, the at least one processor is configured to receive one or more second quantization codebooks according to the agreed quantization method and quantization parameters.

13. The UE-associated entity of claim 1, wherein to determine the quantization codebook, the at least one processor is configured to:
train the quantization codebook at the UE-associated entity based on the encoded and unquantized intermediate vector set; and
receive a final refined quantization codebook from the base station-associated entity.

14. The UE-associated entity of claim 1, wherein to determine the quantization codebook to be applied to the encoded uplink control information, the at least one processor is configured to:
train the quantization codebook at the UE-associated entity based on the encoded and unquantized intermediate vector set; and
generate a final refined quantization codebook based on a second quantization codebook from the base station-associated entity or a reconstruction codebook from the base station-associated entity.

15. A base station-associated entity, comprising:
at least one memory; and
at least one processor coupled to the at least one memory, the at least one processor configured to:
receive a sequential training dataset from at least a first UE-associated entity, the sequential training dataset including:
one of an input vector set or an output vector set; and
one of an encoded and unquantized intermediate vector set or an encoded and quantized intermediate vector set;
determine a quantization codebook to be applied to encoded and quantized uplink control information; and
train a decoder to decode the encoded and quantized uplink control information based on the sequential training dataset and the quantization codebook.

16. The base station-associated entity of claim 15, wherein the at least one processor is further configured to determine a level of agreement between a first UE vendor and a base station equipment vendor, wherein to train the decoder, the at least one processor is configured to determine the quantization codebook, or a content of the sequential training dataset based on the level of agreement.

17. The base station-associated entity of claim 16, wherein the at least one processor is further configured to deploy the decoder and the quantization codebook to one or more base stations for use with a UE of the first UE vendor.

18. The base station-associated entity of claim 15, wherein the at least one processor is configured to train the decoder based on a loss function between the input vector set or the output vector set and an output vector set from the decoder applied to the encoded and unquantized intermediate vector set or the encoded and quantized intermediate vector set.

19. The base station-associated entity of claim 15, wherein the at least one processor is further configured to receive a sequential training dataset from a second UE-associated entity, and wherein the decoder includes first vendor specific layers, second vendor specific layers, and shared decoder layers.

20-28. (canceled)

29. A method performed at a user equipment (UE) associated entity, comprising:
training an encoder to encode uplink control information;
determining a quantization codebook to be applied to the encoded uplink control information; and
sharing a sequential training dataset with a base station-associated entity, the sequential training dataset including:
one of an input vector set or an output vector set; and
one of an encoded and unquantized intermediate vector set or an encoded and quantized intermediate vector set.

30. (canceled)
